(19) United States
(12) Patent Application Publication
(10) Pub. No.: US 2017/0140431 A1
(43) Pub. Date: May 18, 2017

(54) SYSTEM AND METHOD FOR PROVIDING VALIDATED RETAIL PROMOTIONS

(71) Applicant: CHECKPOINT SYSTEMS, INC., Thorofare, NJ (US)

(72) Inventors: Tracey G. Dwyer, Wayne, NJ (US); Uwe Sydon, Glen Mills, PA (US); Philip Word Morrow, Rockport, MA (US)

(21) Appl. No.: 14/944,362

(22) Filed: Nov. 18, 2015

(51) Int. Cl. G06Q 30/02; G06Q 10/08

(52) U.S. Cl. CPC G06Q 30/0261; G06Q 10/087

(57) ABSTRACT

A retail promotion validation engine may include processing circuitry. The processing circuitry may be configured to receive information indicative of a location of a consumer relative to a commercial environment, determine a product associated with the location, perform an inventory check to determine whether the product is in stock proximate to the location, and send promotional material to the consumer based on the inventory check.

### TECHNICAL FIELD

Various example embodiments relate generally to the provision of promotional materials, and more specifically relate to a system and method for identifying and validating products to be promoted to selected consumers.

### BACKGROUND

The provision of promotional materials to potential consumers is a well-known and yet evolving sales driver. From catalogues and coupon-ladened newspapers to television commercials, billboards and popup ads, promotional marketing has advanced with technology. More recently, efforts have been made to study and profile users in order to target users with ads that are thought to have a greater likelihood of achieving a positive response.

Success in a promotional marketing context can certainly be measured based on sales figures. However, on a more basic level, the sale could not occur without first gaining the attention of the consumer, and enticing the consumer to inquire about the corresponding product in the first place. Thus, the success of the promotional marketing effort may actually relate to the amount of interest generated by the promotional materials.

In situations where the amount of interest generated is high, or at least when the amount of interest correlates to a demand that is greater than the current supply of products, a lack of inventory to enable supply to meet the demand can mask the true effect of the promotional marketing. Such a situation can also be frustrating to a shopper who responds to a promotion only to find that the product promoted is not in stock. Thus, it may be preferable to improve marketing processes to ensure that the above mentioned scenario can be avoided.

### BRIEF SUMMARY OF SOME EXAMPLES

Some example embodiments may provide an ability to identify consumers to target for retail promotions. However, the targeting may be further dependent upon a check to ensure that the corresponding product that is the subject of the retail promotion is in stock. Accordingly, a situation where marketing materials are effective in enticing a potential customer to show interest in a product that is not in stock anyway can be avoided.

In one example embodiment, a retail promotion validation engine including processing circuitry is provided. The processing circuitry may be configured to receive information indicative of a location of a consumer relative to a commercial environment, determine a product associated with the location, perform an inventory check to determine whether the product is in stock proximate to the location, and send promotional material to the consumer based on the inventory check.

According to another example embodiment, a promotion generation system is provided. The promotion generation system may include a one or more locator devices configured to locate a communication device in a commercial environment and a retail promotion validation engine operably coupled to the one or more locator devices. The retail promotion validation engine may include processing circuitry. The processing circuitry may be configured to receive information indicative of a location of a consumer relative to a commercial environment, determine a product associated with the location, perform an inventory check to determine whether the product is in stock proximate to the location, and send promotional material to the consumer based on the inventory check.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a conceptual diagram of a commercial environment according to an example embodiment;

FIG. 2 illustrates a block diagram of a retail promotion validation engine that may be employed to generate promotional materials for objects (products) in the commercial environment in accordance with an example embodiment;

FIG. 3 illustrates a block diagram of a process flow according to an example embodiment; and

FIG. 4 illustrates a block diagram of a method of validating promotional materials according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

The ubiquity of mobile communication devices, such as smartphones, has enabled the creation of a highly connected society in which people are available to interact with other people and devices on a nearly continuous basis. The inherent nature of the mobile communication devices that provide this level of connectivity places such devices in states where they are transmitting and/or receiving information of some type or another frequently. By virtue of their nearly continuous connectivity, these devices are often detectable and/or locatable in the corresponding areas in which they are carried by their users.

Some example embodiments may enable the use of these devices both as a mechanism by which to select an individual or individuals to receive promotional materials and as targets for the promotional materials. The selection may be made based on the location of the individual (or time spent at the location) and the proximity of that location to a product. However, example embodiments may further provide for an inventory check to be conducted relative to the product prior to the transmission of promotional materials to the selected individual. Accordingly, for example, the location of an individual (and/or the time spent or behavior of the individual at the location) may be used to select a promotional message corresponding to a product having some association with the location. Prior to sending the selected promotional message, an inventory check for the product may be conducted. The inventory check may be conducted for the location or an area proximate to the location. If sufficient inventory of the product is at or near the location, then the promotional message may be sent to the individual.

Example embodiments may therefore validate the existence of a product in inventory prior to sending promotional marketing materials related to the product. The promotional marketing, which may include or otherwise be associated with retail item promotions, may therefore be considered to be validated retail promotions since the retail promotions to be sent have already been validated or confirmed to be available in inventory. Some example embodiments may therefore avoid frustrating potential customers by sending promotional materials to solicit interest in a product that is not in stock. As such, example embodiments may also generally increase the effectiveness of marketing promotions since genuine interest in a product will be more likely to result in a sale as local inventory is known to support the sale.

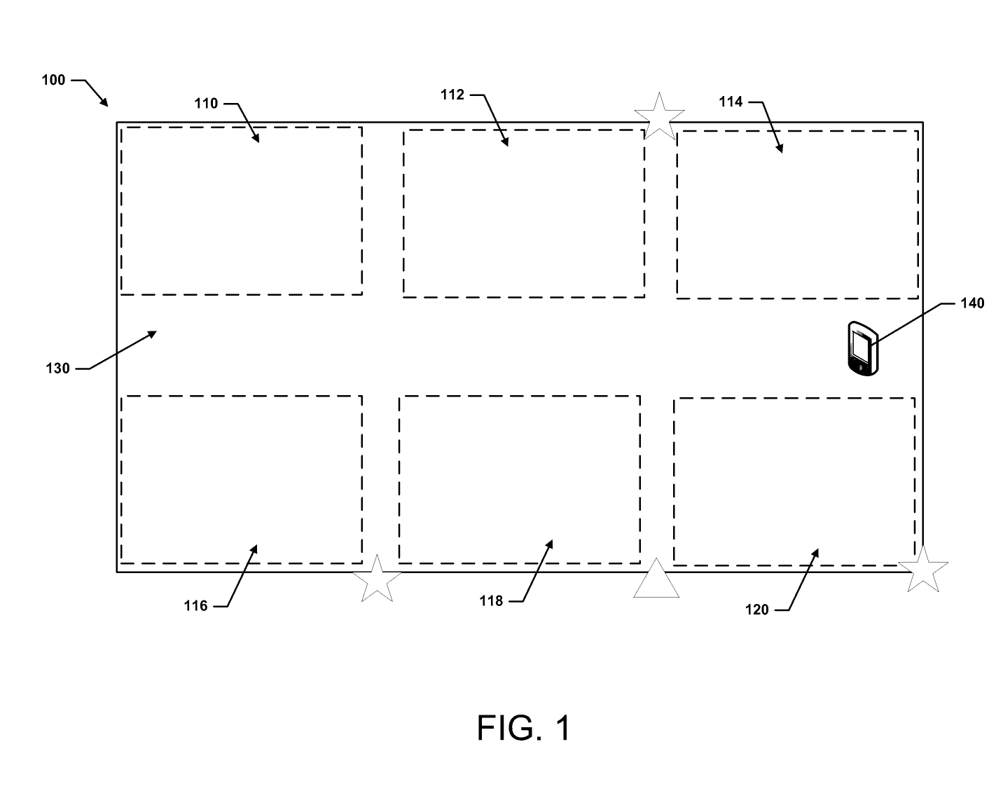

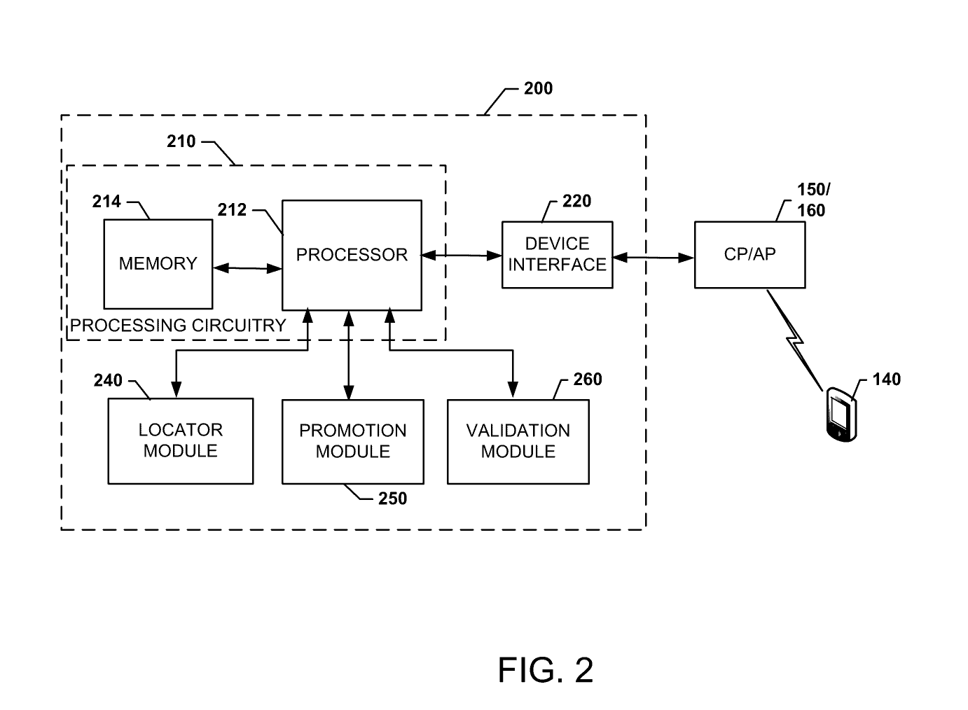

FIG. 1 illustrates a conceptual diagram of an area in which an example embodiment may be employed. FIG. 2 illustrates a block diagram of a validated retail promotion system that may be employed in the area of FIG. 1 to provide validated retail promotions in accordance with an example embodiment. As shown in FIG. 1, the area of interest in which an example embodiment may be practiced can be considered to be a commercial environment 100. The commercial environment 100 may include a plurality of zones (e.g., first zone 110, second zone 112, third zone 114, fourth zone 116, fifth zone 118 and sixth zone 120). Each of the zones may be associated with a different product, brand, retailer and/or the like, and the zones may be separated by a transit area 130 or some other open space. However, in some cases, the zones may be immediately adjacent to each other.

In an example embodiment in which the commercial environment 100 is a shopping mall, strip mall or other such area, the zones may correspond to different stores. The transit area 130 may therefore correspond, for example, to the concourse of the shopping mall. However, the commercial environment 100 could alternatively correspond to an individual store or a department store. In such an example, the zones may correspond to departments, brands, product types or even individual product displays, and the transit area 130 may correspond to aisles within the store or department. Thus, the commercial environment 100 and the practice of example embodiments relative to the commercial environment 100 should be appreciated as being a scalable concept that can be applied to different sizes and scopes of retail or other sales environments in which product inventory can be validated prior to sending promotional materials.

As shown in FIG. 1, a communication device 140 (e.g., a smartphone, PDA, cell phone, or other device capable of wireless communication) may be carried by a user within the transit area 130 of the commercial environment 100. With reference to FIG. 2, the communication device 140 may be capable of wireless communication with one or more wireless communication points (CPs) 150 that may be positioned in or proximate to the commercial environment 100. The CPs 150 may be capable of employment within a location system or in connection with determining communication device 140 location as described herein. The CPs 150 may be access points, transmitters, receivers or transceivers associated with a local or wide area communication network, or may be any other wireless communication devices that are capable of detecting the presence (and in some cases also identity) of the communication device 140 to determine location information indicative of the location of the communication device 140. Thus, for example, the CPs 150 may be wireless transmitters, receivers or transceivers associated with or embodied as, for example, low-power wireless terrestrial devices, such as, Bluetooth beacons. According to some example embodiments, the CPs 150 may be associated with or embodied as WiFi presence detection systems, real-time locating system (RTLS) locating techniques via WiFi or Bluetooth (e.g., angle of arrival (AOA), time difference of arrival (TDOA), etc.), global positioning system (GPS) positioning, near field communication (NFC) and/or the like. In some cases, the CPs 150 may be associated with a cellular communication network that is capable of using triangulation or other locating techniques to determine a location of the communication device 140 relative to the CPs 150. When the location information is GPS-based, the CPs 150 may be GPS satellites. Information provided by the CPs may also be usable for determining time spent at the location (e.g., dwell time), as described below.

In an example embodiment, one or more access points (APs), such as AP 160, that may also be provided in or proximate to the commercial environment 100. The AP 160 may be a communication network asset that is configured to communicate wirelessly with the communication device 140. In some cases, the AP 160 may be a base station of a cellular network or other local or wide area communication network. As such, in some examples, the AP 160 could be a CP 150, or the CP 150 may be a component of an AP 160. However, in other examples, the AP 160 and the CPs 150 may be devices of different (related or unrelated) communication networks.

The CPs 150 may be employed to determine location information associated with a physical position of a communication device 140 for provision to a retail promotion validation engine 200 of an example embodiment. One example structure of the retail promotion validation engine 200 is shown in FIG. 2. In this regard, the retail promotion validation engine 200 may include processing circuitry 210 that may be configured to interface with, control or otherwise coordinate the operations of various components or modules described herein in connection with executing retail promotion validation as described herein. The retail promotion validation engine 200 may utilize the processing circuitry 210 to provide electronic control inputs to one or more functional units of the retail promotion validation engine 200 to receive, transmit and/or process data associated with the one or more functional units and perform communications necessary to enable the ability to locate a consumer (e.g., associated with the communication device 140), select promotion materials associated with a product based on the location (and/or based on profile information associated with the consumer), and validate the promotion materials prior to sending of the promotion materials as described herein.

In some embodiments, the processing circuitry 210 may be embodied as a chip or chip set. In other words, the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 210 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 210 may include one or more instances of a processor 212 and memory 214 that may be in communication with or otherwise control a device interface 220. As such, the processing circuitry 210 may be embodied as a circuit chip (e.g., an integrated circuit chip) configured (e.g., with hardware, software or a combination of hardware and software) to perform operations described herein.

The device interface 220 may include one or more interface mechanisms for enabling communication with other devices (e.g., CPs 150, AP 160, and/or other devices). In some cases, the device interface 220 may be any means such as a device or circuitry embodied in either hardware, or a combination of hardware and software that is configured to receive and/or transmit data from/to devices or components in communication with the processing circuitry 210 via internal and/or external communication mechanisms. Accordingly, for example, the device interface 220 may further include wired and/or wireless communication equipment (e.g., one or more antennas) for at least communicating with CPs 150, AP 160, and/or the modules described herein. In some cases, the device interface 220 may therefore include one or more antenna arrays that may be configured or configurable to receive and/or transmit properly formatted signals associated with CPs 150 and/or AP 160. The device interface 220 may further include radio circuitry configured to encode and/or decode, modulate and/or demodulate, or otherwise process wireless signals received by or to be transmitted by the antenna array(s).

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform the operations described herein in reference to execution of an example embodiment.

In an exemplary embodiment, the memory 214 may include one or more non-transitory memory devices such as, for example, volatile and/or non-volatile memory that may be either fixed or removable. The memory 214 may be configured to store information, data, applications, instructions or the like for enabling the processing circuitry 210 to carry out various functions in accordance with exemplary embodiments of the present invention. For example, the memory 214 may be configured to buffer input data for processing by the processor 212. Additionally or alternatively, the memory 214 may be configured to store instructions for execution by the processor 212. As yet another alternative or additional capability, the memory 214 may include one or more databases that may store a variety of data sets or tables useful for operation of the modules described below and/or the processing circuitry 210. Among the contents of the memory 214, applications or instruction sets may be stored for execution by the processor 212 in order to carry out the functionality associated with each respective application or instruction set. In some cases, the applications/instruction sets may include instructions for carrying out some or all of the operations described in reference to the algorithms or flow charts described herein. In particular, the memory 214 may store executable instructions that enable the computational power of the processing circuitry 210 to be employed to improve the functioning of the retail promotion validation engine 200 relative to the tracking/locating a consumer, selecting promotional materials corresponding to a product to be marketed to the consumer, and validating that the product is in inventory at a location proximate to the consumer as described herein. As such, the improved operation of the computational components of the retail promotion validation engine 200 transforms the retail promotion validation engine 200 into a more capable tracking/locating, content selecting and notification device relative to the products and consumers associated with executing example embodiments.

As shown in FIG. 2, the retail promotion validation engine 200 may further include (or otherwise be operably coupled to) a locator module 240, a promotion module 250 and/or a validation module 260. In some examples, the processor 212 (or the processing circuitry 210) may be embodied as, include or otherwise control various modules (e.g., the locator module 240, the promotion module 250 and/or the validation module 260) that are configured to perform respective different tasks associated with the retail promotion validation engine 200. As such, in some embodiments, the processor 212 (or the processing circuitry 210) may be said to cause each of the operations described in connection with the various modules described herein. However, it should be appreciated that the modules could be remotely located from the processing circuitry 210 in some cases and may therefore employ their own processing circuitry in such cases.

The locator module 240 may be any means such as a device or circuitry embodied in either hardware, or a combination of hardware and software that is configured to receive information from the CPs 150 to determine a location of the communication device 140 (and therefore also the location of a consumer associated with the communication device 140) based on wireless communication between the communication device 140 and the CPs 150. In some embodiments, the location may be determined along with a dwell time. The dwell time may be indicative of the amount of time that the consumer has spent at or near the location. Thus, for example, if the consumer is walking through the commercial environment 100 and notices a product of interest, the consumer may pause to inspect the product. The period of time that the consumer spends inspecting the product may be identified by the locator module 240 as dwell time during which the consumer is not moving.

Thus, for example, the locator module 240 may be configured to receive information from the CPs 150 and process the information to determine the location information applicable for the communication device 140. The locator module 240 may also track the communication device 140 based on monitoring and updating the location information over a period of time. The location information may be recorded and/or communicated to the promotion module 250 for further processing as described below. Alternatively or additionally, when subsequent location information has changed less than a threshold amount, a dwell time measurement may commence. Once the dwell time reaches a predetermined threshold, a trigger signal may be sent to the promotion module 250 (e.g., along with the location information) to indicate that promotional materials are to be selected for a product corresponding to the location (and/or to a profile of the consumer). Accordingly, in some embodiments, the locator module 240 may track and/or monitor the location of the communication device 140 or otherwise provide updates to the location information over time to provide such information (with or without dwell time) to the promotion module 250.

Various different techniques can be employed for generating the location information. For example, the CPs 150 may be Bluetooth beacons and the communication device 140 may receive communications from the CPs along with a beacon ID. The beacon ID may be reported (as location information) along with identifying information associated with the consumer (e.g., a shopper or subscriber identity). In examples where the CPs 150 employ other ranging and/or locating techniques, the location information may take other forms. However, where possible, identifying information associated with the consumer may accompany the location information for further processing at the promotion module 250.

The promotion module 250 may be any means such as a device or circuitry embodied in either hardware, or a combination of hardware and software that is configured to receive the location information (and also identifying information, if applicable) to determine a product associated with the location and/or promotional material (e.g., a message, coupon, offer, and/or the like) associated with the product to provide as message content that is to be communicated to the communication device 140 via the AP 160. Of note, the product may be near the location, or a store or retail outlet that typically carries the product may be near (or easily accessible from) the location.

In some cases, the promotion module 250 may be configured to select the promotional material exclusively based on the location information. For example, a product database or table may be provided to indicate associations of products to corresponding locations. In this regard, the first zone 110 may be associated with a corresponding first product (or outlet carrying the first product), the second zone 112 may be associated with a second product (or outlet carrying the second product), etc. Thus, if the communication device 140 is located in, proximate to or within a predetermined distance from the first zone 110, the first product may be identified as being associated with the location of the consumer. The product database or table may also include corresponding message content (e.g., promotional material) that is correlated with the first product. However, in some cases, the message content may be in a separate database that is consulted after the product is identified. The promotion module 250 may then generate or format a message having the corresponding message content for delivery to the communication device 140 based on operation of the validation module 260. However, in other cases, the message content and/or the generation or formatting of the message may be further dependent upon dwell time and/or consumer identity.

If dwell time is an applicable consideration, the dwell time may be required to reach the predetermined threshold before message formatting or generation is accomplished and/or before the corresponding product and/or promotional material are identified. If consumer identity is an applicable consideration, the identifying information may be used to access a consumer profile for the owner of the communication device 140. The consumer profile may be generated based on monitoring consumer activity (e.g., movement, online purchases, bricks-and-mortar retail purchases, returns, online reviews and ratings, etc.), or based on registration of the consumer to a service associated with the retail promotion validation engine 200. Further, consumer profile information may include age, gender, annual household income, geographic region neighborhood of residence, number of members of the consumer's family, ages and gender of family members and/or friends, clothes sizing information for both the family and friends, and the like. In some embodiments, the profile information may indicate a contact address (e.g., an email address, phone or text message number or address, or other preferred method by which the consumer should be reached with the message content). However, in some cases, the profile information may further indicate details about preferences of the consumer and/or recent behavior of the consumer that may be employed to guide selection of the message content. For example, if this is the third time in a week that the consumer has stopped to look at the same product, an offer or coupon may be provided or the value of the offer or coupon may be increased over the last message content provided. Other profile information may ensure that, for example, gender appropriate products or products applicable to an expressed interest provided by the consumer are selected as appropriate for the identifying information. Other preference information (e.g., brands, products, sizes, colors, price guidelines or alerts, etc.) may also be employed for product selection and/or content selection. Moreover, in some cases, loyalty points or other activity related rewards or bonuses may be employed for selection of the message content and/or the value of any offers, coupons and/or the like to be provided in the message content. Regardless of the message content selected, the promotional materials (e.g., the message content) may not be transmitted to the communication device 140 until the validation module 260 performs validation procedures as described below.

Accordingly, promotional materials may be selected in a static manner (e.g., selecting a pre-formatted promotion of a fixed value) for a product in some cases. However, in other cases, promotional material selection may be conducted in a more dynamic fashion. Dynamic selection may allow formatting and value of promotional materials to be selected on the basis of situational considerations such as current situational details matching customer preferences, customer behavior triggering a format or value change, a need for competitive enticement to steer attention from a competitor or other conditional enticements. In some example embodiments, dynamic selection may be performed based on the activity and behavior of numerous consumers, and not simply based on a single consumer.

The validation module 260 may be any means such as a device or circuitry embodied in either hardware, or a combination of hardware and software that is configured to receive information indicative of the product that is associated with the promotional materials (e.g., the message content) and, in some cases, the location information. The validation module 260 may then be configured to validate the message content, which may include confirming or otherwise determining that the product is in inventory at or proximate to an outlet proximate to (or within a predetermined distance of) the location indicated by the location information. In this regard, for example, the product may be looked up or queried in an inventory management system to determine whether the product is in inventory (locally, regionally, or globally) at the present time. However, it should be appreciated that the validation module 260 and the promotion module 250 can operate in parallel or in any sequence as soon as the product is identified.

In an example embodiment, communication flow may initially pass between the locator system and the communication device of the consumer to identify location of the consumer for product selection. In some cases, the product selection may be performed locally at servers of a business in the commercial environment 100, although such selection may alternatively be conducted by a device or server in the cloud. The product selection may include consultation of a consumer information database (e.g., for registered or known consumers) and/or a product-location table or database. The inventory check may be accomplished via consultation with an inventory database maintained locally or in the cloud. Thereafter, the promotional materials may be sent to the consumer.

In some cases, the validation may be location specific and thus the inventory check may only be for the closest outlet to the location information. However, in other cases, if the closest outlet does not have the product in inventory, the message content may be modified to indicate the location of (and/or directions to) an alternate outlet within a given distance of the location indicated by the location information. In some cases, message content may always be modified to indicate the location of the outlet for which the promotional material is applicable. When the inventory check is completed and the message content can be sent to the consumer identifying the location of an outlet at which the promotional materials provided in the message can be redeemed, the message content may be considered to be validated. Validated message content may be delivered to the consumer to ensure that the consumer only receives promotional materials for products that are actually in stock nearby the consumer.

If no outlet within the given distance has the product in inventory, the validation may fail and the message content may not be delivered. However, in some embodiments, a message content modification may be generated in response to an initial validation attempt that fails. The message content modification may include an indication that the product is not in inventory locally and/or an offer for free shipping or another inducement relative to an online shopping opportunity.

In operation, for example, the fourth zone 116 may be a television or electronic equipment display. The locator module 240 may monitor consumer location and determine that the consumer exceeded the dwell time based on staying in the vicinity of the fourth zone 116 for more than the predetermined threshold. The location information, and the fact that the dwell time was exceeded, may be provided to the promotion module 250. The promotion module 250 may use the location information to determine that television product offers and/or promotional materials are applicable based on the consumer's location and/or behavior. However, consumer preferences associated with registration information provided by the consumer may indicate that the consumer prefers Brand A. Accordingly, promotional materials corresponding to televisions produced by Brand A may be selected for provision to the consumer. The consumer preferences or registration information may also provide an email address or text message number for the consumer so that the message content can be delivered to the consumer by the preferred contact mechanism. In some example embodiments, the message content may be provided to the customer via an application (e.g., an Apple or Android app) that has been installed of the communication device. However, before the message content can be delivered, the validation module 260 may determine whether the televisions produced by Brand A are in stock locally (e.g., at the store associated with the fourth zone 116). Promotional materials may be validated and delivered for selected television sizes and/or models that are in stock. Thus, if certain screen sizes are not in stock, the message content may be modified to make the message content only applicable to those products (i.e., screen sizes) that are in stock as indicated by the inventory query. Similarly, promotional materials related to clothing items may be validated to ensure the consumer's size is in stock before such materials are delivered. Where appropriate, directions to the zone or other location at which the product corresponding to the promotional materials can be found may also be included. Validation on the basis of other preferences may also be accomplished.

In some embodiments, the functionality and capabilities of the retail promotion validation engine 200 may be augmented or combined with product locating systems. For example, location information and product locating information indicating that the consumer has a certain product in their cart (e.g., not yet purchased), may be used by the promotion module 250 to generate promotional materials for other related products that may be generally paired or associated with the certain product in the cart. Thus, if the consumer has a Brand A widget in the consumer's cart, and the consumer is identified by location information as being proximate to Brand A's widget enhancer, the retail promotion validation engine 200 may send promotional materials related to Brand A's widget enhancer to the consumer after the inventory check is successfully completed by the validation module 260. Product steering may therefore be accomplished on the basis of consumer preference or brand or manufacturer initiated enticements associated with related products. Product steering may also be implemented in a competitive context. Thus, for example, a competing brand or manufacturer may generate conditional enticements that have values that increase when it can be determined that the consumer is in proximity to or likely to purchase a product that is made by a competitor. For example, if the dwell time near such product (or near a store or outlet having competing products) would indicate interest, a conditional enticement may be generated. Accordingly, the competing brand or manufacturer may be able to steer attention of the consumer away from the product made by the competitor. As such, consumer activity associated with a competitor's product may trigger generation of promotional materials.

In some cases, the conditional enticement may also or alternatively be generated based on online shopping items left in the on-line shopping cart. Thus, for example, if the consumer was shopping and left a product (item A) in the consumer's shopping cart, but did not complete the transaction, and item A also happens to be located in the commercial environment 100 at the fifth zone 118. If the consumer is detected proximate to the fifth zone 118, the retail promotion validation engine 200 may generate promotional materials to attempt to entice the consumer to purchase item A while nearby. The promotional materials may provide a price reduction for purchase locally, after inventory validation is completed.

As mentioned above, the locator module 240, the promotion module 250 and the validation module 260 may all be associated with a single instance of the retail promotion validation engine 200. Moreover, the retail promotion validation engine 200 may be embodied at a computer or server of a retail outlet or store that forms, includes or is a part of the commercial environment 100. However, in some cases, components of the retail promotion validation engine 200 may be distributed. For example, the locator module 240 may be separate from the retail promotion validation engine 200 but may communicate therewith. The locator module 240 may therefore communicate with the CPs 150, AP 160 and/or the device interface 220 to allow the location information to be provided to the retail promotion validation engine 200 for the other functions of modules associated with the retail promotion validation engine 200 as described herein to be supported.

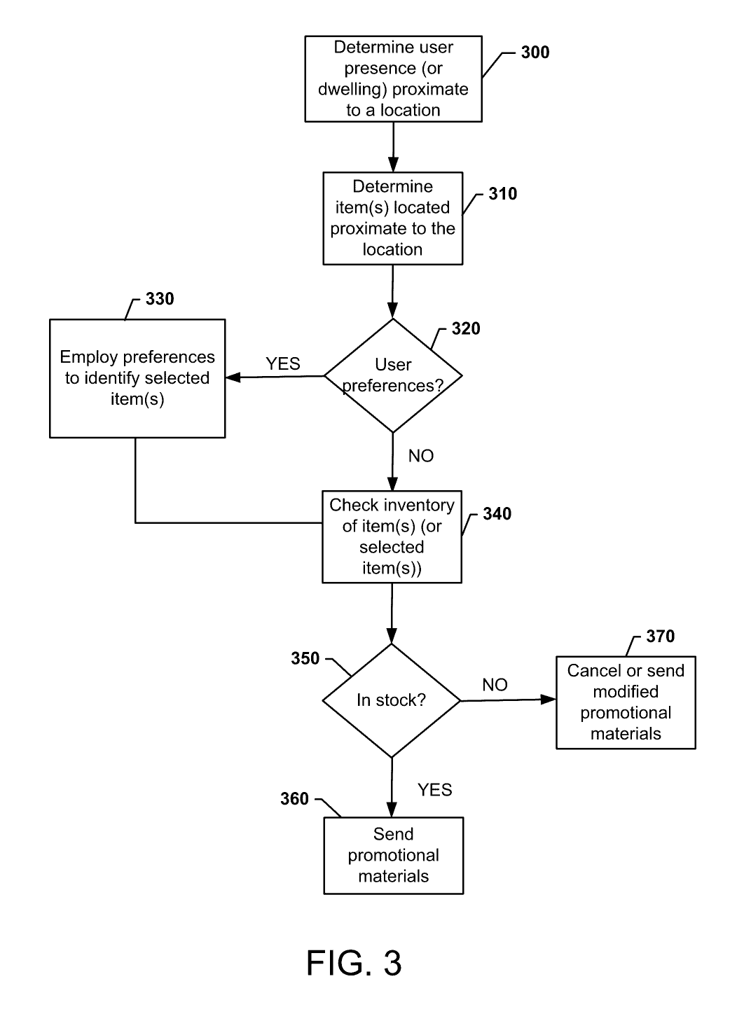

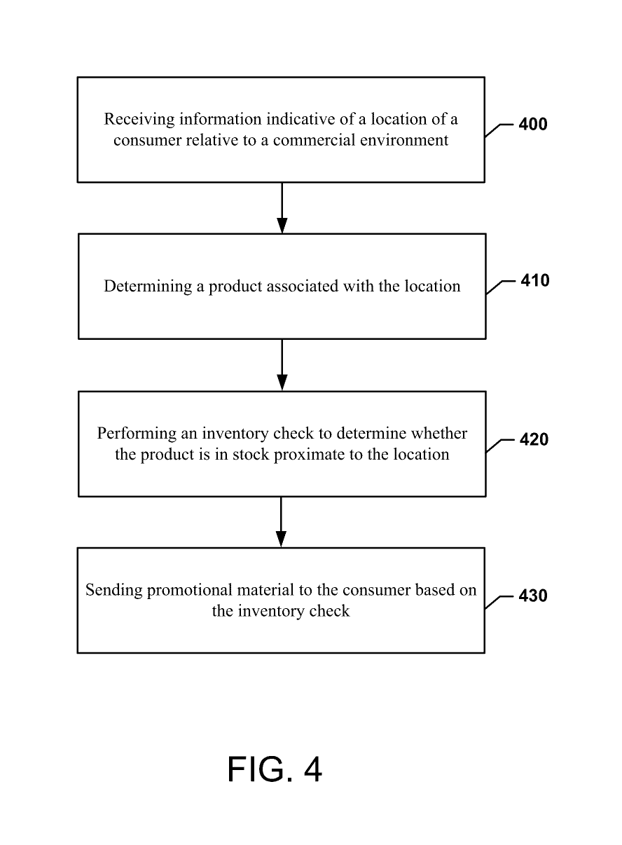

From a technical perspective, the retail promotion validation engine 200 described above may be used to support some or all of the operations described above. As such, the platforms described in FIGS. 1 and 2 may be used to facilitate the implementation of one or more computer program and/or network communication based interactions. As an example, FIGS. 3 and 4 are flowcharts of example methods and program products according to an example embodiment of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, FIG. 3 illustrates a block diagram showing a control flow representative of an algorithm executable in connection with a system employing the retail promotion validation engine 200 in accordance with an example embodiment. As shown in FIG. 3, a determination may initially be made that the consumer is proximate to (or dwelling at) a location at operation 300. At operation 310, a determination may be made as to what items are located proximate to the location. Optionally, a determination may be made as to whether the consumer has preferences (e.g., sizes, brands, etc.) for the items located proximate to the location at operation 320. The preferences, if applicable, may be used to identify selected items at operation 330. If there are no preferences, or after selected items are identified, an inventory check may then be conducted for the items (or selected items) at operation 340. A determination may be made, based on the inventory check, as to whether the items are available (i.e., in stock) for the consumer at operation 350. If the items are in stock, at operation 360, a promotion may be sent to the user in response to the inventory check determining that the items are available. If the items are not in stock, no promotion may be sent, or a modified promotion may be generated and sent at operation 370.

FIG. 4 illustrates a block diagram of a method of validating promotional materials in accordance with an example embodiment. In this regard, for example, the method may include receiving information indicative of a location of a consumer relative to a commercial environment at operation 400. The method may further include determining a product associated with the location at operation 410 and performing an inventory check to determine whether the product is in stock proximate to the location at operation 420. The method may further include sending promotional material to the consumer based on the inventory check at operation 430.

In some embodiments, the features described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, the method may further include receiving identifying information indicative of an identity of the consumer and determining user preferences based on the identity information, wherein determining the product comprises determining the product based on the user preferences. In such cases, sending the promotional material comprises selecting message content based on the user preferences. Alternatively or additionally, sending the promotional material comprises sending the promotional material via a message delivered to a contact address selected based on the user preferences. In an example embodiment, determining the product associated with the location may include determining one or more products located proximate to the location in a product database. In some embodiments, sending the promotional material may include modifying message content of the promotional material based on the inventory check indicating that the product is not in stock. In such an example, modifying message content comprises providing free shipping for an online purchase of the product. In an example embodiment, sending the promotional material may include providing message content based on consumer activity associated with the product outside the commercial environment. In some embodiments, the consumer activity comprises leaving the product in an online shopping cart. In an example embodiment, the sending the promotional material may include providing message content based on consumer activity associated with a competitive product.

Example embodiments may provide a promotion validation system that can statically or dynamically generate promotional materials based on consumer location and the products associated with such location. However, example embodiments may further ensure that the corresponding products are in stock before the promotional materials are sent to the consumer to avoid frustrating situations where a consumer receives promotional materials for products that are not in stock. Sales of products may be increased, and the satisfaction of customers may also be improved with targeted promotions that are supportable with available inventory.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A retail promotion validation engine comprising processing circuitry configured to:
receive information indicative of a location of a consumer relative to a commercial environment;
determine a product associated with the location;
perform an inventory check to determine whether the product is in stock proximate to the location; and
send promotional material to the consumer based on the inventory check.

2. The retail promotion validation engine of claim 1, wherein determining the product associated with the location comprises determining one or more products located proximate to the location in a product database.

3. The retail promotion validation engine of claim 1, further comprising receiving identifying information indicative of an identity of the consumer and determining user preferences based on the identity information, wherein determining the product comprises determining the product based on the user preferences.

4. The retail promotion validation engine of claim 3, wherein sending the promotional material comprises selecting message content based on the user preferences.

5. The retail promotion validation engine of claim 3, wherein sending the promotional material comprises sending the promotional material via a message delivered to a contact address selected based on the user preferences.

6. The retail promotion validation engine of claim 1, wherein sending the promotional material comprises modifying message content of the promotional material based on the inventory check indicating that the product is not in stock.

7. The retail promotion validation engine of claim 6, wherein modifying message content comprises providing free shipping for an online purchase of the product.

8. The retail promotion validation engine of claim 1, wherein sending the promotional material comprises providing message content based on consumer activity associated with the product outside the commercial environment.

9. The retail promotion validation engine of claim 8, wherein the consumer activity comprises leaving the product in an online shopping cart.

10. The retail promotion validation engine of claim 1, wherein sending the promotional material comprises providing message content based on consumer activity associated with a competitive product.

11. A promotion generation system comprising:
one or more locator devices configured to locate a communication device in a commercial environment; and
a retail promotion validation engine operably coupled to the one or more locator devices, the retail promotion validation engine comprising processing circuitry configured to:
receive information indicative of a location of a consumer relative to a commercial environment;
determine a product associated with the location;
perform an inventory check to determine whether the product is in stock proximate to the location; and
send promotional material to the consumer based on the inventory check.

12. The promotion generation system of claim 11, wherein determining the product associated with the location comprises determining one or more products located proximate to the location in a product database.

13. The promotion generation system of claim 11, further comprising receiving identifying information indicative of an identity of the consumer and determining user preferences based on the identity information, wherein determining the product comprises determining the product based on the user preferences.

14. The promotion generation system of claim 13, wherein sending the promotional material comprises selecting message content based on the user preferences.

15. The promotion generation system of claim 13, wherein sending the promotional material comprises sending the promotional material via a message delivered to a contact address selected based on the user preferences.

16. The promotion generation system of claim 11, wherein sending the promotional material comprises modifying message content of the promotional material based on the inventory check indicating that the product is not in stock.

17. The promotion generation system of claim 16, wherein modifying message content comprises providing free shipping for an online purchase of the product.

18. The promotion generation system of claim 11, wherein sending the promotional material comprises providing message content based on consumer activity associated with the product outside the commercial environment.

19. The promotion generation system of claim 18, wherein the consumer activity comprises leaving the product in an online shopping cart.

20. The retail promotion validation engine of claim 11, wherein sending the promotional material comprises providing message content based on consumer activity associated with a competitive product.
